(19) United States
(12) Patent Application Publication
(10) Pub. No.: US 2015/0108094 A1
(43) Pub. Date: Apr. 23, 2015

(54) METHOD AND DEVICE FOR GAS METAL ARC WELDING

(71) Applicants: Erwan Siewert, Munich (DE); Rolf Heninger, Hohenkirchen-Siegertsbrunn (DE)

(72) Inventors: Erwan Siewert, Munich (DE); Rolf Heninger, Hohenkirchen-Siegertsbrunn (DE)

(21) Appl. No.: 14/488,404

(22) Filed: Sep. 17, 2014

(30) Foreign Application Priority Data
Oct. 22, 2013 (DE) 102013017591.7

(51) Int. Cl. B23K 9/16; B23K 9/32

(52) U.S. Cl. CPC B23K 9/164; B23K 9/325
USPC 219/74

(57) ABSTRACT

A method and device for gas metal arc welding, wherein a wire electrode is melted by an arc, wherein the arc burns between the wire electrode and a work piece, wherein an inert gas is supplied in the form of an inert gas flow, wherein emissions are released in the form of emission particles during gas metal arc welding, and wherein at least one flow gradient is generated in the direction of the work piece for agglomerating the emission particles.

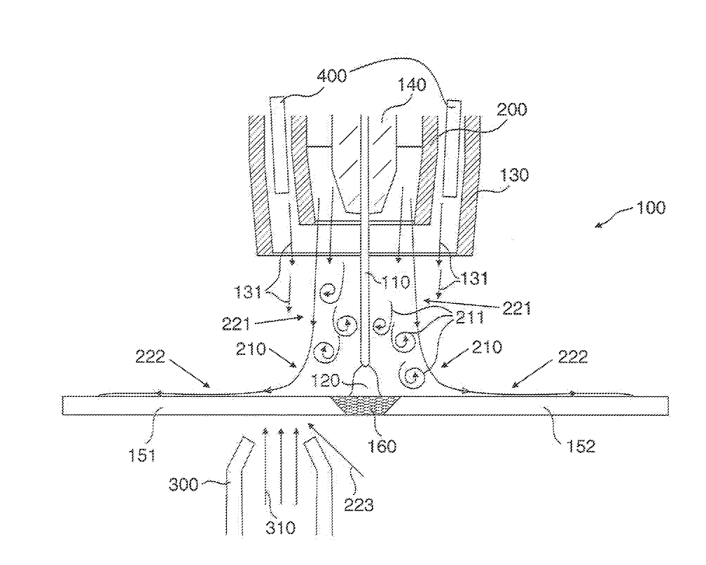

### CROSS REFERENCE TO RELATED APPLICATIONS

This application claims priority from German patent application DE102013017591.7 filed Oct. 22, 2013.

### BACKGROUND OF THE INVENTION

The invention relates to a method and device for gas metal arc welding. A wire electrode is here melted by an arc, wherein the arc bums between the wire electrode and a work piece. An inert gas is supplied in the form of an inert gas flow. Emissions are here released in the form of emission particles during gas metal arc welding.

Gas metal arc welding (GMA welding) involves an arc welding method that is used for the overlay welding, welding or soldering of one, two or more work pieces made out of metal materials. In an inert gas atmosphere, a wire electrode is here continuously fed in the form of a wire or belt and melted by an arc that burns between the work piece and wire electrode. The work piece here serves as a second electrode. In particular, the work piece here serves as a cathode, and the wire electrode as an anode. The cathode effects here at least partially melt the work piece, and form the molten bath. The end of the wire electrode is melted, and predominantly the arc yields a molten drop. Various forces cause the drop to detach from the wire electrode, and pass over into the molten bath. This process of melting the wire electrode, forming the drop, detaching the drop and having the drop interact with the work piece is referred to as material transfer.

In gas metal arc welding, a plurality of emissions is released in the form of gas, radiation and welding fumes. Welding fumes here denotes particulate contaminants (hereinafter referred to as emission particles). Such emission particles are released in particular through the evaporation of the wire electrode. The emission particles, most often metal oxides, are most frequently aerosols having a diameter of less than 100 nm. As a consequence, these emission particles are among the breathable particles that can get into the body through the mouth and nose, but can also be absorbed through the skin. In addition, the emission particles are alveolar particles, i.e., the emissions can penetrate through to the alveoli (air sacs) during respiration. In particular, the emission particles can be toxic and/or carcinogenic. Therefore, these emission particles are especially hazardous to the health of a welder due to a poor solubility as well.

In order to reduce the loads and health risk for the welder, gas masks can be used, or the emission particles can be aspirated with a suction burner. However, suction burners are associated with major disadvantages. Suction burners have a more cumbersome design and a greatly restricted accessibility. Moreover, they are much harder to handle by the welder. Furthermore, the ultrafine emission particles can often not be separated out by basic filters. In addition to that, the emission particles most frequently empty out close to the material surface, and are difficult, if not impossible, to detect with the suction burner.

Therefore, the object of the invention is to reduce the health risk posed to the welder during gas metal arc welding by the released emission particles.

This object is achieved by a method and device for gas metal arc welding with the features in the independent claims. In a method according to the invention, a wire electrode is melted by an arc, wherein the arc burns between the wire electrode and a work piece. An inert gas is supplied in the form of an inert gas flow. According to the invention, at least one flow gradient is generated in the direction of the work piece for agglomerating the emission particles. Additional embodiments may be gleaned from the subclaims and the following description.

In another embodiment of the invention, there is disclosed a device for gas metal arc welding, exhibiting a wire electrode, an inert gas nozzle designed to supply an inert gas in the form of an inert gas flow, wherein gas metal arc welding results in the release of emissions in the form of emission particles, characterized in that it encompasses a device designed to generate at least one flow gradient in the direction of a work piece for agglomerating the emission particles.

The emission particles released during gas metal arc welding are generated especially by the evaporation of the wire electrode. In particular, such emission particles are fine or ultrafine particles, and have a diameter in particular of less than 1 μm, further in particular of less than 100 nm. As a result, the emission particles are respirable and alveolar, posing a significant health risk to the welder. In particular, the emission particles are toxic and carcinogenic. The emission particles cause acute or chronic damage to human health, in particular when breathed in, swallowed or absorbed through the skin. The emission particles are predominantly deleterious substances classified as danger category “Xn”. In particular, the emission particles are substances that are toxic (danger category “T”) or even highly toxic “T+”). Slight or even very slight amounts of such substances lead to death or cause acute or chronic damage to the health when breathed in, swallowed or absorbed through the skin.

According to the invention, the emission particles are agglomerated, or an agglomeration of emission particles is induced. The emission particles collide, adhere to each other, and thereby form agglomerates (the word agglomerates denotes agglomerated emission particles below). Already a slight increase in size causes the emission particles to sink, so that they no longer get into the respiratory area of the welder. In particular, the agglomerates can have at least ten times the diameter than the individual emission particles, and thus a size not critical with respect to health.

The respirable, alveolar emission panicles are thus agglomerated into larger particles that are no longer alveolar, in particular that can no longer even be breathed in. In addition, the size of these agglomerates is here such that the agglomerates “sag” under the force of gravity, and become deposited on the work piece. The invention greatly reduces the danger that a welder will breathe in emission particles. This makes it possible to tangibly reduce the health risks during gas metal arc welding, as well as to increase working safety.

The invention reduces the health risk during the gas metal arc welding of all substances. The melting wire electrode supplies additional filler material to the molten bath. In particular substances like chromium, nickel and/or manganese are often used as filler materials. These filler materials are constituents of the wire electrode, and are melted along with the latter. However, these substances can also evaporate and be released as emission particles. For example, emission particles like manganese oxides, nickel oxides and/or chromium(VI) compounds are here released. Manganese oxides are toxic and/or toxic-irritative, with manganese being suspected of causing Parkinson's. But manganese is an important filler material, in particular during the gas metal arc welding of construction steel. Nickel oxides and chromium(VI) compounds are carcinogenic. Chromium and nickel are especially important filler materials for the gas metal arc welding of high-alloyed steel. The invention makes it possible to use substances like these during gas metal arc welding without any worries, while still tangibly reducing health risks.

In an advantageous embodiment of the invention, a gas flow is guided in the direction of the work piece with the at least one flow gradient for agglomerating the emission particles. In particular, a gas is supplied in the form of the gas flow with the at least one flow gradient for agglomerating the emission particles. In particular, the gas flow streams from one blowtorch in the direction of the work piece. In particular, the gas flow is supplied in the form of a gas curtain between the blowtorch and work piece. The gas flow or flow gradient of the gas flow causes the emission particles to collide and agglomerate. In the following, “gas flow” is to be understood as a gas flow for agglomerating the emission particles, unless specified otherwise.

The gas flow can here be a laminar gas flow. The gas flow streams without any turbulences (swirls or transverse flows) coming about. The flow gradient can here in particular be caused by a diminishing speed of the gas flow from the blowtorch toward the work piece. The gas flow can also be a turbulent gas flow in which turbulences arise. The turbulences amplify the effect of colliding and agglomerating emission particles. Such a turbulent gas flow in particular exhibits several flow gradients. These flow gradients describe in particular local turbulences in the gas flow. In particular, these local turbulences can also be described by a (global) flow gradient.

In particular, argon, carbon dioxide, argon, carbon dioxide, oxygen, helium and hydrogen or mixtures thereof can be supplied in the form of the gas flow. Water mist or water vapor can also be supplied in the form of the gas flow. In addition, hydrogen has the effect of not oxidizing the emission particles. This is important especially for substances that only lead to the formation of poisonous/toxic or deleterious emission particles through oxidation, for example to the formation of Cr(VI).

In an advantageous embodiment of the invention, the gas flow has at least one temperature gradient for condensing the agglomerated emission particles. As a result, the emission particles are first agglomerated to form larger agglomerates on the one hand, and these agglomerates ultimately condense on the other, in particular on the work piece and/or blowtorch. In addition, the temperature gradient accelerates the agglomeration of emission particles. While the agglomerates in particular are no longer alveolar, they could still be breathed in. The danger that a welder might breathe in emission particles or agglomerates can be further reduced by condensing the agglomerates. By agglomerating and condensing the emission particles, the welder breathes in virtually no emission particles, if any at all. As a consequence, the health risk during gas metal arc welding is tangibly reduced once again, and the working safety is further increased.

The at least one temperature gradient is preferably generated by exposing the work piece to the gas flow. In particular, the gas flow is applied or fed to the work piece in the form of a gas curtain by the blowtorch. As a result, the temperature gradient is generated in particular by the gas curtain. The gas or gas flow is heated especially by the arc. Since the work piece is colder than the arc, the gas or gas flow cools when the gas flow is applied to the work piece, thereby generating the temperature gradient. In particular, the gas flow is guided over the (comparatively cold) surface of the work piece. In the process, the temperature gradient is further increased, and the gas or gas flow can cool further. This further amplifies the agglomerate condensation effect.

Cooled areas of the work piece are preferably exposed to the gas flow. On the one hand, these cooled areas can come about naturally in a spontaneous manner, for example by having the temperature of the work piece taper starting from a weld seam or molten bath. On the other hand, the cooled areas can also be generated in a targeted fashion by actively cooling the corresponding areas.

The cooled areas of the work piece are preferably (actively) cooled or generated by means of an additional cooling gas flow. To this end, a suitable cooling gas is supplied to the corresponding areas of the work piece in the form of a cooling gas flow. The cooling gas flow can here be fed to the work piece from above or below. In particular, the cooling gas flow can also be supplied by the blowtorch. In particular, the work piece is here cooled in a region around the weld seam. Since the gas flow for agglomeration is best fed to the work piece in regions around the weld seam, it especially makes sense to cool these areas of the work piece. The work piece is here preferably cooled in an area of 300 mm around the weld seam.

The cooling gas flow can in particular be supplied by means of a suitable nozzle (hereinafter referred to as cooling gas nozzle). The cooling gas nozzle can here be part of the blowtorch or device for gas metal arc welding. Alternatively or additionally, the cooling gas nozzle can also be a separate component, wherein the cooling gas flow is fed to the work piece independently of the blowtorch. In particular, the cooling gas initially is present in a liquid aggregate state. The cooling gas (especially at the cooling gas nozzle) is depressurized, thereby cooling it further. Carbon dioxide is preferably used for the cooling gas flow, which passes from a liquid aggregate state into the solid and gaseous state during depressurization.

In an advantageous embodiment, a temperature gradient is generated by introducing a cooling surface into the gas flow and/or into the inert gas flow. In particular, the cooling surface is introduced in proximity to a nozzle of the blowtorch, especially in proximity to an inert gas nozzle for supplying the inert gas flow. The agglomerates are here drawn to this cooling surface, in particular by a partial pressure and temperature difference, and condense on the cooling surface. As a result, the effect of condensing the emission particles or agglomerates can be accelerated. The cooling surface can be designed as part of the blowtorch or as an additional separate component. In particular, the cooling surface is situated in such a way as to essentially come into contact with the inert gas in the form of the inert gas flow. This prevents the condensation of atmospheric humidity from the environment of the blowtorch from taking place.

A surface of one heat exchanger or cooling element is preferably used as the cooling surface. The heat exchanger here in particular exhibits a system of cooling lines, wherein this system is closed especially toward the arc. A suitable cooling liquid, in particular liquid carbon dioxide, is depressurized in the cooling lines. The cooling liquid here passes over to both the solid and gaseous aggregate state. This gas exits the cooling lines without disturbing the arc in the process.

The inert gas flow is preferably fed annularly around the wire electrode in the direction of the work piece. To this end, the blowtorch or gas metal arc welding device exhibits a corresponding inert gas nozzle, which is arranged annularly around the wire electrode. The gas flow is preferably also fed annularly around the wire electrode in the direction of the work piece. It is further preferred that the gas flow here be enveloped by the inert gas flow. As an alternative, the inert gas flow can also be enveloped by the gas flow. The blowtorch exhibits a gas flow nozzle for this purpose. In particular, the gas flow nozzle and inert gas nozzle are arranged in such a way as to concentrically envelop the wire electrode. Supplying the gas flow by means of such a gas flow nozzle can especially essentially retain the size of the blowtorch. Furthermore, a rotational symmetry is thereby also maintained for gas metal arc welding or the blowtorch.

The at least one flow gradient is advantageously generated through ultrasound. In particular, ultrasound generates oscillations in the gas flow and the emission particles located therein. This leads to more frequent collisions between the emission particles. The effect of agglomerating the emission particles can thereby be accelerated. In particular, a corresponding device for generating ultrasound is for this purpose situated on a burner head of the blowtorch or gas metal arc welding device. In particular water vapor is supplied. This water vapor is atomized by the ultrasound.

The invention further relates to a corresponding device for gas metal arc welding. Embodiments of this device according to the invention may be analogously gleaned from the above description of the inventive method.

### BRIEF DESCRIPTION OF THE DRAWINGS

The invention and its advantages will now be explained in greater detail based on the attached drawing. The latter shows:

The figure is a schematic view of a preferred embodiment of a gas metal arc welding device according to the invention, which is set up to implement an embodiment of a method according to the invention.

### DETAILED DESCRIPTION OF THE INVENTION

A gas metal arc welding device (GMAW blowtorch) is schematically depicted on the figure and marked 100.

The GMAW blowtorch 100 is used in a joining process to weld a first work piece 151 with a second work piece 152. The GMAW welding device 100 exhibits a current-carrying wire electrode 110 in the form of a wire that is enveloped by a current contact sleeve 140. An electrical voltage is applied between the first work piece 151 and current contact sleeve 140 (not shown). Electrical current flows into the wire electrode 110 by way of the current contact sleeve 140.

An arc 120 is initiated via contact ignition and burns between the current-carrying wire electrode 110 and first work piece 151. The high temperatures melt the tip of the wire electrode 110. This results in a drop of melted wire. The drop finally detaches from the wire electrode 110, passes over to a molten bath 160, and forms the weld seam (joint connection between the work pieces 151 and 152). The wire 110 is here continuously fed. The formation of the drop and detachment of the drop from the wire electrode 110 along with the transfer into the molten bath 160 are referred to as material transfer. The GMAW blowtorch 100 further exhibits an inert gas nozzle 130 to supply (a constant quantity and composition of) inert gas in the form of an inert gas flow, as denoted by reference number 131.

Subjecting the wire electrode 110 to a concentrated application of the arc 120 enables the material transfer of the wire electrode 110. The wire electrode 110 can here become overheated, and the wire electrode 110 can evaporate. Emissions are released in the form of emission particles in particular when the wire electrode 110 evaporates. In order to prevent a welder from breathing in these emission particles, the GMAW blowtorch 100 exhibits a gas flow nozzle 200 and a device for generating ultrasound 400.

The gas flow nozzle 200 is used to feed a gas flow 210 from the GMAW blowtorch 100 in the direction of the work piece 151 or 152. In particular, the gas flow 210 is a turbulent gas flow 210. The gas flow 210 here exhibits turbulences 211. As a result of the turbulences 211, the gas flow 210 exhibits at least one flow gradient.

Alternatively or additionally, the turbulences 211 and hence the at least one flow gradient can here also be generated by the device for generating ultrasound 400.

In particular, the inert gas nozzle 130 and gas flow nozzle 200 are annular in design, and arranged concentrically around the wire electrode 110. As a result, the inert gas flow 131 and gas flow 210 are fed annularly around the wire electrode 110 in the direction of the work piece 151 or 152. In particular, the inert gas nozzle 130 here envelops the gas flow nozzle 200. The inert gas flow 131 thus envelops in particular the gas flow 210. In particular, the gas flow 210 is supplied in the form of a gas curtain between the GMAW blowtorch 100 and work piece 151 or 152.

The turbulent gas flow 210 causes the emission particles to collide. As a result, the emission particles can stick together and agglomerate into larger agglomerates. In particular, this emission particle agglomeration process takes place in a first area 221 between the GMAW blowtorch 100 and work piece 151 or 152.

In a second area 222, the gas flow 210 is directed onto the work piece 151 or 152. Since the temperature of the work piece 151 or 152 diminishes with increasing distance from the molten bath 160, a temperature gradient for the gas flow 210 can be generated. The temperature gradient and diminishing temperature of the gas flow 210 cause the agglomerates to condense on the work piece 151 or 152 in the area 222.

The work piece 151 or 152 can also be actively cooled so as to generate a stronger temperature gradient for the gas flow 210. In particular a cooling gas nozzle 300 can be present for this purpose. The figure exemplarily depicts a cooling gas nozzle for actively cooling the work piece 151 in a third area 223, The third area 223 is here in particular an area of 300 mm around the molten bath 160 or around the weld seam. In addition, the cooling gas nozzle 300 supplies a suitable cooling gas, in particular carbon dioxide, to the third area 223 in the form of a cooling gas flow 310.

The cooling gas nozzle 300 according to the figure is situated under the work piece 151, and guides the cooling gas flow 310 toward the work piece 151, for example from below. Alternatively or additionally, the cooling gas nozzle 300 can also be located above the work piece 151. Alternatively or additionally, the cooling gas nozzle 300 can also be arranged in the GMAW blowtorch 100, in particular (similarly to the inert gas nozzle 130 and gas flow nozzle 200) concentrically around the wire electrode 110.

### REFERENCE LIST

100 GMAW blowtorch
110 Wire electrode
120 Arc
130 Inert gas nozzle
131 Inert gas flow
140 Current contact sleeve
151 Work piece
152 Work piece
160 Molten bath
200 Gas flow nozzle
210 Gas flow
211 Turbulences
221 First area
222 Second area
223 Third area
300 Cooling gas nozzle
310 Cooling gas flow

What we claim is:

1. A method for gas metal arc welding, wherein a wire electrode is melted by an arc, wherein the arc burns between the wire electrode and a work piece, wherein an inert gas is supplied in the form of an inert gas flow, wherein emissions are released in the form of emission particles during gas metal arc welding, characterized in that at least one flow gradient is generated in the direction of the work piece for agglomerating the emission particles.

2. The method according to claim 1, wherein a gas flow with the at least one flow gradient is fed in the direction of the work piece for agglomerating the emission particles.

3. The method according to claim 2, wherein the gas flow comprises at least one temperature gradient for condensing the agglomerated emission particles.

4. The method according to claim 3, wherein a temperature gradient is generated by exposing the work piece to the gas flow.

5. The method according to claim 4, wherein cooled areas of the work piece are exposed to the gas flow.

6. The method according to claim 5, wherein the cooled areas of the work piece are cooled by a cooling gas flow.

7. The method according to claim 6, wherein carbon dioxide is used for the cooling gas flow.

8. The method according to claim 7, wherein the work piece is cooled in an area of a weld seam

9. The method according to claim 8, wherein the workpiece is cooled in an area of 300 mm around the weld seam.

10. The method according to claim 3, wherein a temperature gradient is generated by introducing a cooling surface into the gas flow for agglomerating the emission particles or into the inert gas flow.

11. The method according to claim 10, wherein a surface of the heat exchanger is used as the cooling surface.

12. The method according to claim 1, wherein the inert gas flow is fed annularly around the wire electrode in the direction of the work piece.

13. The method according to claim 12, wherein the gas flow for agglomerating the emission particles is fed annularly around the wire electrode, enveloped by the inert gas flow in the direction of the work piece.

14. The method according to claim 1, wherein the at least one flow gradient is generated by ultrasound.

15. A device for gas metal arc welding, comprising a wire electrode, an inert gas nozzle designed to supply an inert gas in the form of an inert gas flow, wherein gas metal arc welding results in the release of emissions in the form of emission particles, characterized in that it encompasses a device designed to generate at least one flow gradient in the direction of a work piece for agglomerating the emission particles.

16. The device according to claim 15, comprising at least one gas flow nozzle designed to feed a gas flow with the at least one flow gradient in the direction of a work piece for agglomerating the emission particles.

17. The device according to claim 15, comprising a device for generating ultrasound.

18. The device according to claim 15, wherein the device comprises a cooling element, which is arranged in such a way as to come into contact with the inert gas flow and/or gas flow for agglomerating the emission particles.
